(19) United States
(12) Patent Application Publication
(10) Pub. No.: US 2010/0157870 A1
(43) Pub. Date: Jun. 24, 2010

(54) MANAGING A MULTICAST GROUP MEMBERSHIP TABLE AT AN ACCESS NETWORK WITHIN A WIRELESS COMMUNICATIONS SYSTEM

(75) Inventors: Bongyong SONG, San Diego, CA (US); Harleen Gill, San Diego, CA (US); Arulmozhi Kasi Ananthanarayanan, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/339,929

(22) Filed: Dec. 19, 2008

(51) Int. Cl. H04H 20/71

(52) U.S. Cl. 370/312

(57) ABSTRACT

Managing multicast communications within a wireless communications system, including receiving, at an access network, a group status message including a multicast session identifier and at least one access terminal identifier. The access network updates a multicast group membership table based on the group status message. The multicast group membership table is configured to include a list of access terminal identifiers that have registered for the multicast session identified by the multicast session identifier.

### BACKGROUND OF THE INVENTION

1. Field of the Invention

The invention relates to communications in a wireless telecommunication system and, more particularly to a method of managing a multicast group membership table at an access network within a wireless communications system.

2. Description of the Related Art

Wireless communication systems have developed through various generations, including a first-generation analog wireless phone service (1G), a second-generation (2G) digital wireless phone service (including interim 2.5G and 2.75G networks) and a third-generation (3G) high speed data/Internet-capable wireless service. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

The method for providing CDMA mobile communications was standardized in the United States by the Telecommunications Industry Association/Electronic Industries Association in TIA/EIA/IS-95-A entitled “Mobile Station-Base Station Compatibility Standard for Dual-Mode Wideband Spread Spectrum Cellular System,” referred to herein as IS-95. Combined AMPS & CDMA systems are described in TIA/EIA Standard IS-98. Other communications systems are described in the IMT-2000/UM, or International Mobile Telecommunications System 2000/Universal Mobile Telecommunications System, standards covering what are referred to as wideband CDMA (WCDMA), CDMA2000 (such as CDMA2000 1xEV-DO standards, for example) or TD-SCDMA.

In wireless communication systems, mobile stations, handsets, or access terminals (AT) receive signals from fixed position base stations (also referred to as cell sites or cells) that support communication links or service within particular geographic regions adjacent to or surrounding the base stations. Base stations provide entry points to an access network (AN)/radio access network (RAN), which is generally a packet data network using standard Internet Engineering Task Force (IETF) based protocols that support methods for differentiating traffic based on Quality of Service (QoS) requirements. Therefore, the base stations generally interact with ATs through an over the air interface and with the AN through Internet Protocol (IP) network data packets.

In wireless telecommunication systems, Push-to-talk (PTT) capabilities are becoming popular with service sectors and consumers. PTT can support a “dispatch” voice service that operates over standard commercial wireless infrastructures, such as CDMA, FDMA, TDMA, GSM, etc. In a dispatch model, communication between endpoints (ATs) occurs within virtual groups, wherein the voice of one “talker” is transmitted to one or more “listeners.” A single instance of this type of communication is commonly referred to as a dispatch call, or simply a PTT call. A PTT call is an instantiation of a group, which defines the characteristics of a call. A group in essence is defined by a member list and associated information, such as group name or group identification.

Conventionally, data packets within a wireless communication network have been configured to be sent to a single destination or access terminal. A transmission of data to a single destination is referred to as “unicast”. As mobile communications have increased, the ability to transmit given data concurrently to multiple access terminals has become more important. Accordingly, protocols have been adopted to support concurrent data transmissions of the same packet or message to multiple destinations or target access terminals. A “broadcast” refers to a transmission of data packets to all destinations or access terminals (e.g., within a given cell, served by a given service provider, etc.), while a “multicast” refers to a transmission of data packets to a given group of destinations or access terminals. In an example, the given group of destinations or “multicast group” may include more than one and less than all of possible destinations or access terminals (e.g., within a given group, served by a given service provider, etc.). However, it is at least possible in certain situations that the multicast group comprises only one access terminal, similar to a unicast, or alternatively that the multicast group comprises all access terminals (e.g., within a cell or sector), similar to a broadcast.

Broadcasts and/or multicasts may be performed within wireless communication systems in a number of ways, such as performing a plurality of sequential unicast operations to accommodate the multicast group, allocating a unique broadcast/multicast channel (BCH) for handling multiple data transmissions at the same time and the like. A conventional system using a broadcast channel for push-to-talk communications is described in United States Patent Application Publication No. 2007/0049314 dated Mar. 1, 2007 and entitled “Push-To-Talk Group Call System Using CDMA 1x-EVDO Cellular Network”, the contents of which are incorporated herein by reference in its entirety. As described in Publication No. 2007/0049314, a broadcast channel can be used for push-to-talk calls using conventional signaling techniques. Although the use of a broadcast channel may improve bandwidth requirements over conventional unicast techniques, the conventional signaling of the broadcast channel can still result in additional overhead and/or delay and may degrade system performance.

The 3^{rd} Generation Partnership Project 2 (“3GPP2”) defines a broadcast-multicast service (BCMCS) specification for supporting multicast communications in CDMA2000 networks. Accordingly, a version of 3GPP2's BCMCS specification, entitled “CDMA2000 High Rate Broadcast-Multicast Packet Data Air Interface Specification”, dated Feb. 14, 2006, Version 1.0 C.S0054-A, is hereby incorporated by reference in its entirety.

### SUMMARY

Embodiments of the present invention are directed to Managing multicast communications within a wireless communications system, including receiving, at an access network, a group status message including a multicast session identifier and at least one access terminal identifier. The access network updates a multicast group membership table based on the group status message. The multicast group membership table is configured to include a list of access terminal identifiers that have registered for the multicast session identified by the multicast session identifier.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 is a diagram of a wireless network architecture that supports access terminals and access networks in accordance with at least one embodiment of the invention.

FIG. 2 illustrates a carrier network according to an embodiment of the present invention.

FIG. 3 is an illustration of an access terminal in accordance with at least one embodiment of the invention.

FIG. 4 illustrates a conventional process for providing a broadcast multicast service (BCMCS) flow to one or more ATs in the wireless system of FIG. 1.

FIG. 5 illustrates a process for updating a multicast group membership table according to an embodiment of the present invention.

FIG. 6 illustrates another process for updating a multicast group membership table according to an embodiment of the present invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A High Data Rate (HDR) subscriber station, referred to herein as an access terminal (AT), may be mobile or stationary, and may communicate with one or more HDR base stations, referred to herein as modem pool transceivers (MPTs) or base stations (BS). An access terminal transmits and receives data packets through one or more modem pool transceivers to an HDR base station controller, referred to as a modem pool controller (MPC), base station controller (BSC) and/or packet control function (PCF). Modem pool transceivers and modem pool controllers are parts of a network called an access network. An access network transports data packets between multiple access terminals.

The access network may be further connected to additional networks outside the access network, such as a corporate intranet or the Internet, and may transport data packets between each access terminal and such outside networks. An access terminal that has established an active traffic channel connection with one or more modem pool transceivers is called an active access terminal, and is said to be in a traffic state. An access terminal that is in the process of establishing an active traffic channel connection with one or more modem pool transceivers is said to be in a connection setup state. An access terminal may be any data device that communicates through a wireless channel or through a wired channel, for example using fiber optic or coaxial cables. An access terminal may further be any of a number of types of devices including but not limited to PC card, compact flash, external or internal modem, or wireless or wireline phone. The communication link through which the access terminal sends signals to the modem pool transceiver is called a reverse link or traffic channel. The communication link through which a modem pool transceiver sends signals to an access terminal is called a forward link or traffic channel. As used herein the term traffic channel can refer to either a forward or reverse traffic channel.

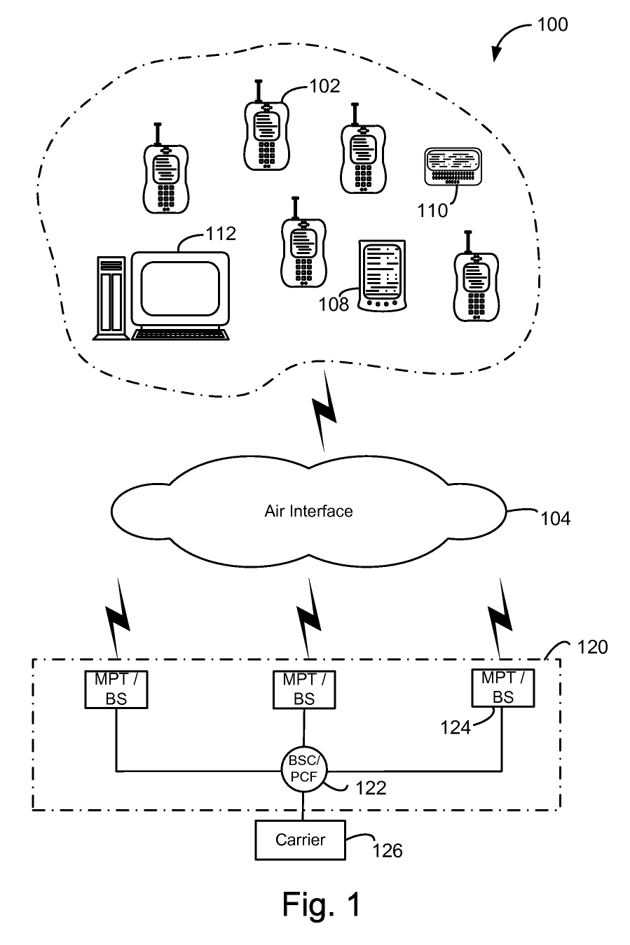

FIG. 1 illustrates a block diagram of one exemplary embodiment of a wireless system 100 in accordance with at least one embodiment of the invention. System 100 can contain access terminals, such as cellular telephone 102, in communication across an air interface 104 with an access network or radio access network (RAN) 120 that can connect the access terminal 102 to network equipment providing data connectivity between a packet switched data network (e.g., an intranet, the Internet, and/or carrier network 126) and the access terminals 102, 108, 110, 112. As shown here, the access terminal can be a cellular telephone 102, a personal digital assistant 108, a pager 110, which is shown here as a two-way text pager, or even a separate computer platform 112 that has a wireless communication portal. Embodiments of the invention can thus be realized on any form of access terminal including a wireless communication portal or having wireless communication capabilities, including without limitation, wireless modems, PCMCIA cards, personal computers, telephones, or any combination or sub-combination thereof. Further, as used herein, the terms “access terminal”, “wireless device”, “client device”, “mobile terminal” and variations thereof may be used interchangeably.

Referring back to FIG. 1, the components of the wireless network 100 and interrelation of the elements of the exemplary embodiments of the invention are not limited to the configuration illustrated. System 100 is merely exemplary and can include any system that allows remote access terminals, such as wireless client computing devices 102, 108, 110, 112 to communicate over-the-air between and among each other and/or between and among components connected via the air interface 104 and RAN 120, including, without limitation, carrier network 126, the Internet, and/or other remote servers.

The RAN 120 controls messages (typically sent as data packets) sent to a base station controller/packet control function (BSC/PCF) 122. The BSC/PCF 122 is responsible for signaling, establishing, and tearing down bearer channels (i.e., data channels) between a packet data serving node 100 (“PDSN”) and the access terminals 102/108/110/112. If link layer encryption is enabled, the BSC/PCF 122 also encrypts the content before forwarding it over the air interface 104. The function of the BSC/PCF 122 is well-known in the art and will not be discussed further for the sake of brevity. The carrier network 126 may communicate with the BSC/PCF 122 by a network, the Internet and/or a public switched telephone network (PSTN). Alternatively, the BSC/PCF 122 may connect directly to the Internet or external network. Typically, the network or Internet connection between the carrier network 126 and the BSC/PCF 122 transfers data, and the PSTN transfers voice information. The BSC/PCF 122 can be connected to multiple base stations (BS) or modem pool transceivers (MPT) 124. In a similar manner to the carrier network, the BSC/PCF 122 is typically connected to the MPT/BS 124 by a network, the Internet and/or PSTN for data transfer and/or voice information. The MPT/BS 124 can broadcast data messages wirelessly to the access terminals, such as cellular telephone 102. The MPT/BS 124, BSC/PCF 122 and other components may form the RAN 120, as is known in the art. However, alternate configurations may also be used and the invention is not limited to the configuration illustrated. For example, in another embodiment the functionality of the BSC/PCF 122 and one or more of the MPT/BS 124 may be collapsed into a single “hybrid” module having the functionality of both the BSC/PCF 122 and the MPT/BS 124.

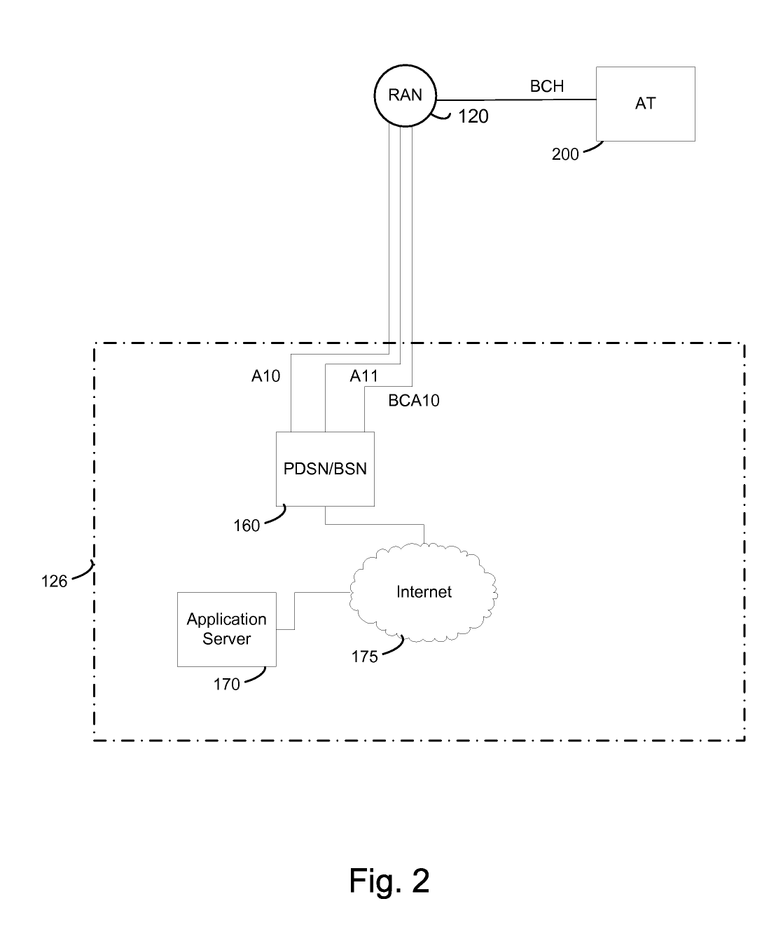

FIG. 2 illustrates the carrier network 126 according to an embodiment of the present invention. In the embodiment of FIG. 2, the carrier network 126 includes a packet data serving node (PDSN) 160 that includes an integrated broadcast service node (BSN) 165, an application server 170 and an Internet 175. However, application server 170 and other components may be located outside the carrier network in alternative embodiments. Further, while the PDSN 160 is illustrated in FIG. 2 as being integrated with the BSN, it will be appreciated that other embodiments of the present invention are directed to a separately-implemented BSN that need not be integrated with the PDSN 160.

Referring to FIG. 2, the PDSN 160 provides access to the Internet 175, intranets and/or remote servers (e.g., application server 170) for mobile stations (e.g., access terminals, such as 102, 108, 110, 112 from FIG. 1) utilizing, for example, a cdma2000 Radio Access Network (RAN) (e.g., RAN 120 of FIG. 1). Acting as an access gateway, the PDSN 160 may provide simple IP and mobile IP access, foreign agent support, and packet transport. The PDSN 160 can act as a client for Authentication, Authorization, and Accounting (AAA) servers and other supporting infrastructure and provides mobile stations with a gateway to the IP network as is known in the art. As shown in FIG. 2, the PDSN 160 may communicate with the RAN 120 (e.g., the BSC/PCF 122) via a conventional A10 connection and/or a conventional A11 connection. The A10 and A11 connections are well-known in the art and will not be described further for the sake of brevity.

Referring to FIG. 2, the BSN, which may be integrated with the PDSN 160, may be configured to support multicast and broadcast services. The BSN communicates with the RAN 120 (e.g., the BSC/PCF 122) via a broadcast (BC) A10 connection, and with the application server 170 via the Internet 175. The BCA10 connection is used to transfer multicast and/or broadcast messaging. Accordingly, the application server 170 can send both unicast messaging and multicast messaging to the PDSN/BSN 160 via the Internet 175.

Generally, as will be described in greater detail below, the RAN 120 transmits multicast messages, received from the PDSN/BSN 160 via the BCA10 connection, over the air interface 104 via a downlink channel (e.g., a broadcast channel (BCH), a control channel, etc.) to one or more access terminals 200.

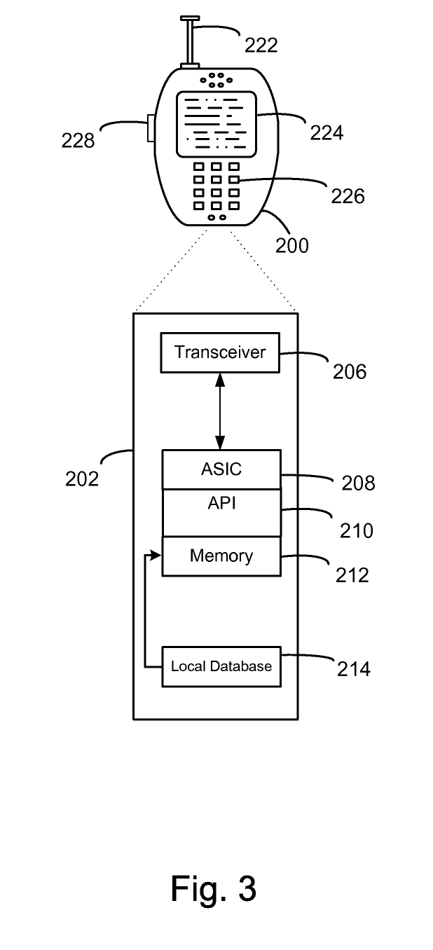

Referring to FIG. 3, an access terminal 200, (here a wireless device), such as a cellular telephone, has a platform 202 that can receive and execute software applications, data and/or commands transmitted from the RAN 120 that may ultimately come from the carrier network 126, the Internet and/or other remote servers and networks. The platform 202 can include a transceiver 206 operably coupled to an application specific integrated circuit (“ASIC” 208), or other processor, microprocessor, logic circuit, or other data processing device. The ASIC 208 or other processor executes the application programming interface (“API”) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can hold applications not actively used in memory 212. The local database 214 is typically a flash memory cell, but can be any secondary storage device as known in the art, such as magnetic media, EEPROM, optical media, tape, soft or hard disk, or the like. The internal platform 202 components can also be operably coupled to external devices such as antenna 222, display 224, push-to-talk button 228 and keypad 226 among other components, as is known in the art.

Accordingly, an embodiment of the invention can include an access terminal including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the access terminal in FIG. 3 are to be considered merely illustrative and the invention is not limited to the illustrated features or arrangement.

The wireless communication between the access terminal 102 and the RAN 120 can be based on different technologies, such as code division multiple access (CDMA), WCDMA, time division multiple access (TDMA), frequency division multiple access (FDMA), Orthogonal Frequency Division Multiplexing (OFDM), the Global System for Mobile Communications (GSM), or other protocols that may be used in a wireless communications network or a data communications network. The data communication is typically between the client device 102, MPT/BS 124, and BSC/PCF 122. The BSC/PCF 122 can be connected to multiple data networks such as the carrier network 126, PSTN, the Internet 175, a virtual private network, and the like, thus allowing the access terminal 102 access to a broader communication network. As discussed in the foregoing and known in the art, voice transmission and/or data can be transmitted to the access terminals from the RAN using a variety of networks and configurations. Accordingly, the illustrations provided herein are not intended to limit the embodiments of the invention and are merely to aid in the description of aspects of embodiments of the invention.

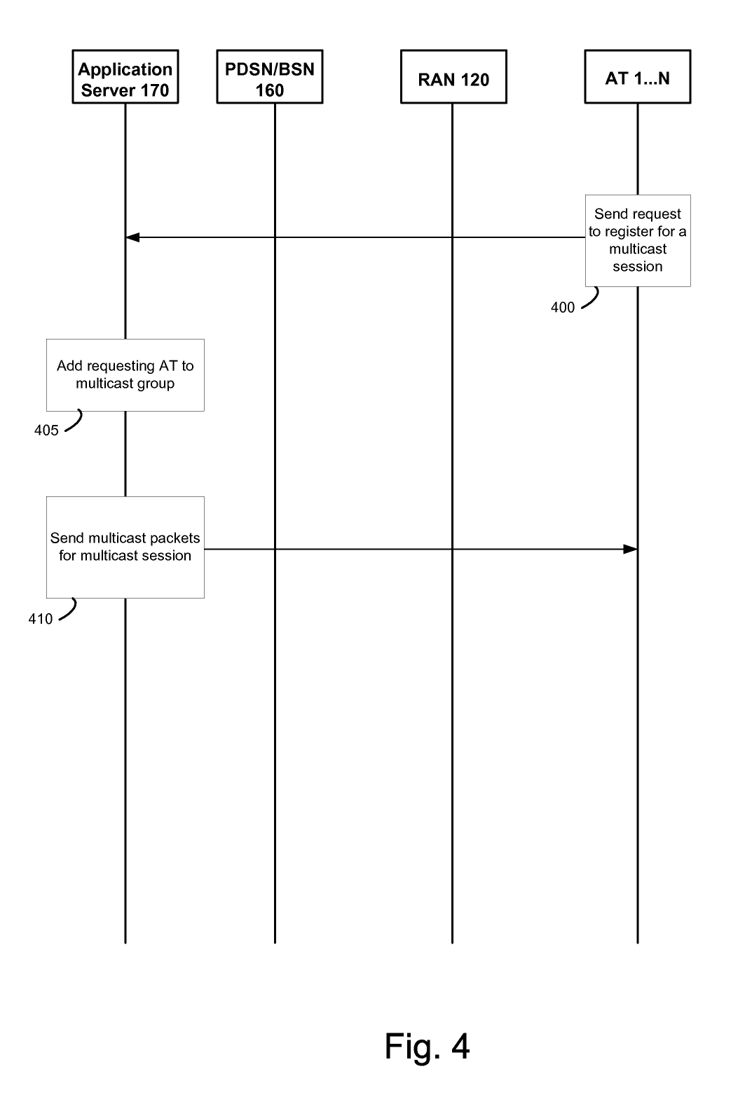

FIG. 4 illustrates a conventional process for providing a broadcast multicast service (BCMCS) flow to one or more ATs 1 . . . N in the wireless system 100 of FIG. 1. Conventionally, if the RAN 120 is operating in accordance with an Open Systems Interconnection (OSI) model, the BSC 122 and BSs 124 operate at layers 1 and/or 2, which correspond to the physical and data link layers, respectively. The PDSN/BSN 160, on the other hand, is configured to operate at layer 3, which corresponds to the network or Internet Protocol (IP) layer.

Accordingly, in 400, one of ATs 1 . . . N sends a request to register (e.g., a BCMCSFlowRegistration message) including a multicast IP address for the announced multicast session and an access terminal (AT) identifier (ID) for an announced multicast session (e.g., a push-to-talk (PTT) session). For example, the AT ID can be embodied as a unicast AT identifier (UATI), as is known in the art. The RAN 120 relays the request to the PDSN/BSN 160 via the physical and data link layers, and the PDSN/BSN 160 decodes the registration request at the IP layer. The registration request is then forwarded from the PDSN/BSN 160 to the application server 170. The application server 170 adds the requesting AT to the multicast group, 405. After the application server 170 (e.g., a PTT server) receives a first registration request, the application server 170 provides packets associated with the multicast session to the PDSN/BSN 160 in accordance with a selected transmission protocol, 410, (e.g., as unicast packets if the number of group members is low, as multicast packets if the number of group members is high, etc.), and the PDSN/BSN 160 begins transmitting the packets associated with the announced multicast session to the RAN 120 (e.g., over a BCA10 connection). In particular, the PDSN/BSN 160 transmits the multicast packets to BSCs from which multicast registration requests have been received, and instructs those BSCs at the RAN 120 to transmit the multicast packets to the multicast group members based on their AT IDs. The RAN 120 (e.g., BSC 122 and potentially other BSCs as well) receives the multicast packets over the BCA10 connection from the PDSN/BSN 160, and transmits the multicast packets to one or more multicast group members.

As will be appreciated by one of ordinary skill in the art, the application server 170 knows which ATs are in a particular multicast group based on a multicast group membership table maintained therein. The multicast group membership table can be updated, 405, based on registration requests, 400. Accordingly, the application server 170 can make decisions affecting multicast communications based on group member information stored within the multicast group membership table. On the other hand, the RAN 120 is not aware of the multicast group associations of its ATs. Further, the RAN 120 maintains a database indicating the serving base stations 124 and/or geographic locations of ATs being served by the RAN 120, whereas the application server 170 is not aware of the serving base stations and/or geographic locations of its multicast group members.

Embodiments of the present invention are directed to maintaining a multicast group membership table at the RAN 120. As discussed above, the RAN 120 is conventionally unaware of the group associations of access terminals during multicast communications, such as PTT communications, because the RAN 120 does not decode packets at the IP layer. In embodiments of the present invention, the RAN 120 is provided with multicast group information from the PDSN/BSN 160, thereby permitting the RAN 120 to maintain its own multicast group membership table, as will be described below in greater detail.

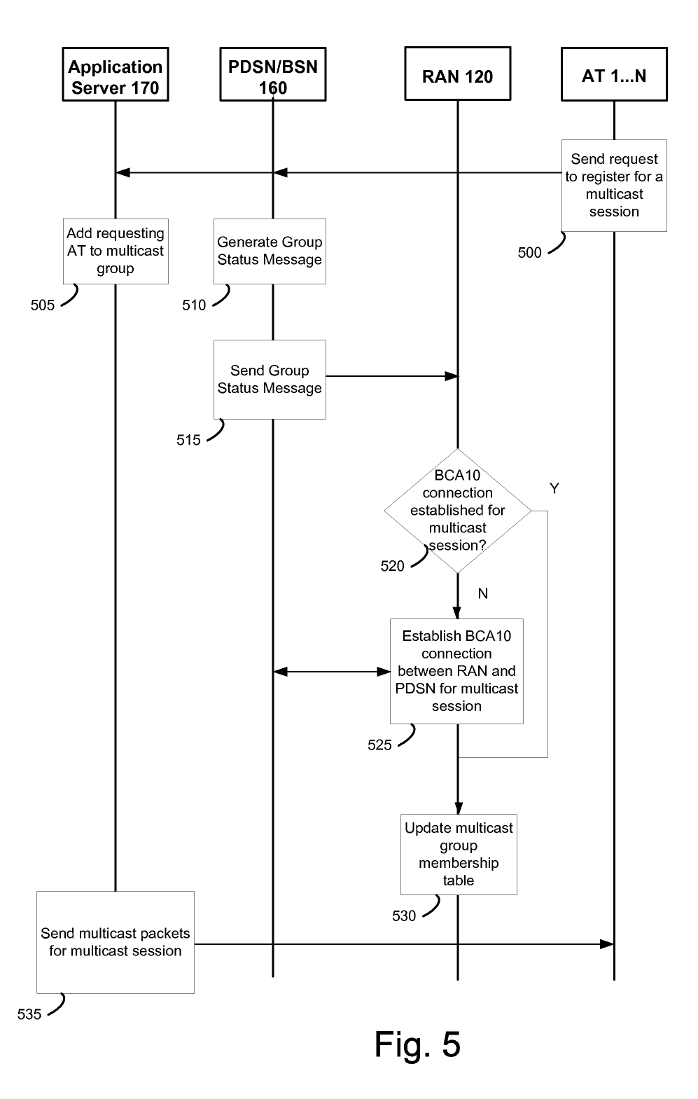

FIG. 5 illustrates a process for updating a multicast group membership table according to an embodiment of the present invention. In 500, one of ATs 1 . . . N sends a request to register (e.g., a BCMCSFlowRegistration message) for an announced multicast session (e.g., a push-to-talk (PTT) session). In an example, the registration request includes an AT ID (e.g., a UATI) of the requesting AT and a multicast IP address of the multicast session for which registration is sought. In a further example, the registration request can be embodied as a BCMCSFlowRegistration message that contains the AT ID and a BCMCSFIowID for the announced multicast session, where the BCMCSFIowID can be configured to include the multicast IP address and port number for the announced multicast session. Examples of configuring a BCMCSFIowID to include a multicast IP address and port number for an announced multicast session are described within U.S. Provisional Application No. 60/974,827, filed on Sep. 24, 2007, entitled “METHODS OF GENERATING MULTICAST FLOW IDENTIFIERS”, assigned to the assignee hereof and hereby incorporated by reference in its entirety.

Referring to FIG. 5, the RAN 120 relays the registration request to the PDSN/BSN 160 via the physical and data link layers. After the PDSN/BSN 160 receives the registration request, the PDSN/BSN 160 decodes the registration request at the IP layer, and forwards the decoded IP packet to the application server 170. The application server 170 adds the requesting AT to the multicast group, 505 (e.g., by adding the requesting AT to a multicast group membership table maintained at the application server 170, as in 405).

Again referring to FIG. 5, after the PDSN/BSN 160 receives and decodes the registration request, the PDSN/BSN 160 generates a group status message (GSM), 510. The GSM includes at least (i) the multicast IP address of the multicast group to be registered and (ii) the AT ID for the requesting AT. In an example, the GSM may include the BCMCSFIowID for the multicast session if the BCMCSFIowID is configured to include the multicast IP address and port number of the multicast session, as discussed above.

After generating the GSM in 510, the PDSN/BSN 160 sends the GSM to the RAN 120 (e.g., to the BSC 122 from which the registration request was received). Upon receiving the GSM from the PDSN/BSN 160, in 520, the RAN 120 determines whether a BCA10 connection has been established between the PDSN/BSN 160 and the BSC 122 from which the registration request was sent. If the RAN 120 determines that the BCA10 connection has not been established in 515, a BCA10 connection is established between the PDSN/BSN 160 and the BSC 122 in 525, and the process then advances to 530. If the RAN 120 determines that the BCA10 connection has already been established in 515, the process advances directly to 530 without establishing another BCA10 connection.

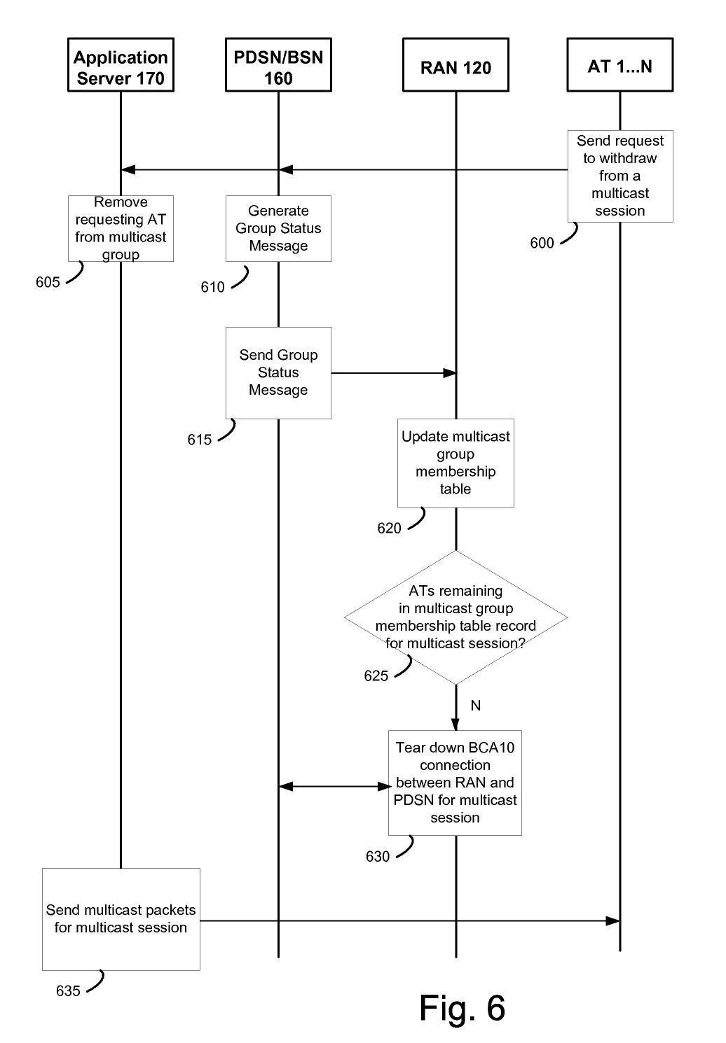

Referring to FIG. 5, in 530, the RAN 120 either generates or updates a multicast group membership table, or binding record, based on the GSM. The multicast group membership table includes a listing of AT IDs associated with a particular multicast IP address at a particular BSC. The RAN 120 can include multiple BSCs, with more than one BSC potentially maintaining its own multicast group membership table for the same multicast IP address, with each BSC's multicast group membership table includes AT ID entries for ATs being served by that BSC . . . . In an example, the AT IDs in the multicast group membership table are the AT IDs included in the registration request, 500, as extracted by the PDSN/BSN 160 and indicated by one or more GSMs. Accordingly, it will be appreciated that the GSM of 510/515 in FIG. 5 can be representative of one of many GSMs sent for a multicast session, such that, in an example, one GSM is sent per AT registration (or de-registration, as described below with respect to FIG. 6).

Referring again to 530 of FIG. 5, in an example, assume the GSM sent in 515 is the first GSM sent in association with the multicast session, the GSM includes a BCMCSFIowID for the multicast session that contains a multicast IP address of 210.276.9.134, and the AT ID for the requesting AT is 6276. With these assumptions, the multicast group membership table may be generated as follows:

| | |
|---|---|
| Multicast IP Address | 210.276.9.134 |
| AT ID(s) | #6276 |

### Multicast Group Membership Table 1

In another example of 530 of FIG. 5, assume the GSM sent in 515 is the third GSM sent in association with the multicast session, the GSM includes a BCMCSFIowID for the multicast session that contains a multicast IP address of 210.276.9.134, and the AT ID for the requesting AT is 6276. With these assumptions, the multicast group membership table may be updated as follows:

| | |
|---|---|
| Multicast IP Address | 210.276.9.134 |
| AT ID(s) | #13243, #546, #6276 |

### Multicast Group Membership Table 2

In 535, the application server 170 (e.g., a PTT server) sends packets associated with a multicast session to the RAN 120 via the PDSN/BSN 160 (e.g., via a BCA10 connection, an A10 connection, etc.) for transmission to one or more multicast group members among ATs 1 . . . N.

FIG. 6 illustrates another process for updating a multicast group membership table according to an embodiment of the present invention. In 600, one of ATs 1 . . . N sends a request to withdraw or de-register from a multicast session to which the requesting AT has previously registered. In an example, the de-registration request can be configured as a supplemental group membership notification (GMN) message as described within U.S. Provisional Application No. 60/974,832, filed on Sep. 24, 2007, entitled “METHODS OF DE-REGISTERING A MULTICAST GROUP MEMBER FROM A MULTICAST GROUP WITHIN A WIRELESS COMMUNICATIONS NETWORK”, assigned to the assignee hereof and hereby incorporated by reference in its entirety.

Referring to FIG. 6, after the PDSN/BSN 160 receives the de-registration request from the RAN 120, the PDSN/BSN 160 decodes the de-registration request at the IP layer and forwards the decoded IP packet to the application server 170. The application server 170 removes or de-registers the requesting AT from the multicast group, 605 (e.g., by deleting the requesting AT from a multicast group membership table maintained at the application server 170).

After receiving and decoding the de-registration request at the PDSN/BSN 160, the PDSN/BSN 160 generates a group status message (GSM), 605. Similar to the GSM of 510 in FIG. 5, the GSM generated in 610 includes at least (i) the multicast IP address of the multicast group to be de-registered and (ii) the AT ID for the requesting AT (e.g., a UATI). In an example, the GSM may include the BCMCSFIowID for the multicast session if the BCMCSFIowID is configured to include the multicast IP address and port number of the multicast session, as discussed above.

After generating the GSM in 610, the PDSN/BSN 160 sends the GSM to the RAN 120 (e.g., to the BSC 122 from which the registration request was received). Upon receiving the GSM from the PDSN/BSN 160, in 615, the RAN 120 updates the multicast group membership table, or binding record, for the multicast session based on the GSM, 620. In this case, because the AT is requesting to withdraw or re-register from the multicast group/session, the GSM instructs the RAN 120 to delete the AT from the multicast group membership table.

In an example, assume that the GSM sent in 615 requests de-registration from a multicast group having a multicast IP address of 210.276.9.134, that the multicast group membership table includes numerous AT IDs and that the AT ID for the requesting AT is 6276. With these assumptions, the multicast group membership table is updated, 620, by deleting the AT ID 6276 for multicast IP address 210.276.9.134. In an alternative example, assume the same scenario as in the above example except the only remaining AT ID in the multicast group membership table for 210.276.9.134 is 6276 (i.e., prior to the de-registration). In this case, the multicast group membership table is updated, 620, by deleting the entirety of the multicast group membership table for multicast IP address 210.276.9.134 (i.e., because the multicast group membership table is now empty, implying the multicast session is over).

After updating the multicast group membership table in 620, the BSC 122 at the RAN 120 determines whether any AT IDs remain within the multicast group membership table for the multicast session, 625. If the BSC 122 determines that no AT IDs remain in the multicast group membership table, the RAN 120 tears down the BCA10 connection, 630, that was previously established between the BSC 122 and the PDSN/BSN 160 (e.g., in 520 of FIG. 5).

As will be appreciated by one of ordinary skill in the art upon a review of FIGS. 5 and 6, the GSMs provided to the RAN 120 from the PDSN/BSN 160 permit each BSC to track the group membership associations of ATs participating in the multicast session. As noted above, the RAN 120 conventionally does not have this group membership information because the RAN 120 does not decode the IP layer of multicast packets being routed therein.

The group membership information enables increased functionality at the RAN 120. For example, the application server 170 will typically determine whether to facilitate a multicast session via unicast packets or multicast packets based on the total number of multicast group members (e.g., a low number of multicast group members may receive unicast packets to avoid overhead associated with multicast protocols, wherein a high number of multicast group members would receive multicast packets). However, based on the multicast group membership table, the RAN 120 may be able to override the transmission protocol determined by the application server 170 in certain situations. This example is described in more detail within co-pending application no. UNKNOWN, filed by the inventors of the subject application, entitled “METHODS OF DETERMINING TRANSMISSION PROTOCOLS FOR MULTICAST COMMUNICATIONS WITHIN A WIRELESS COMMUNICATIONS NETWORK”, filed on the same date as the subject application, having attorney docket no. 071130 and hereby incorporated by reference in its entirety.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of managing multicast communications within a wireless communications system, comprising:
receiving, at an access network, a group status message including a multicast session identifier and at least one access terminal identifier; and
updating, at the access network, a multicast group membership table based on the group status message, the multicast group membership table including a list of access terminal identifiers that have registered for the multicast session identified by the multicast session identifier.

2. The method of claim 1, wherein the group status message is received at the access network from a packet data serving node (PDSN).

3. The method of claim 2, wherein the access network is not configured to decode packets at a network layer, and the PDSN is configured to decode packets at the network layer.

4. The method of claim 3, wherein the group status message conveys information associated with a packet sent to the PDSN from the access network.

5. The method of claim 4, wherein the packet is a multicast group registration request or a multicast group de-registration request.

6. The method of claim 1, wherein, if the group status message indicates to register one or more access terminals identified by the at least one access terminal identifier, the updating step adds the at least one access terminal identifier to the multicast group membership table for the multicast session identified by the multicast session identifier.

7. The method of claim 6, further comprising:
establishing a BC-A10 connection for the multicast session identified by the multicast session identifier if a BC-A10 connection is not yet active for the multicast session identified by the multicast session identifier.

8. The method of claim 1, wherein, if the group status message indicates to de-register one or more access terminals identified by the at least one access terminal identifier, the updating step removes the at least one access terminal identifier from the multicast group membership table for the multicast session identified by the multicast session identifier.

9. The method of claim 8, further comprising:
releasing a BC-A10 connection for the multicast session identified by the multicast session identifier if a BC-A10 connection remains active for the multicast session identified by the multicast session identifier and no access terminals remain registered for the multicast session identified by the multicast session identifier within the multicast group membership table.

10. An access network, comprising:
means for receiving a group status message including a multicast session identifier and at least one access terminal identifier; and
means for updating a multicast group membership table based on the group status message, the multicast group membership table including a list of access terminal identifiers that have registered for the multicast session identified by the multicast session identifier.

11. The access network of claim 10, wherein the group status message is received at the access network from a packet data serving node (PDSN).

12. The access network of claim 11, wherein the access network is not configured to decode packets at a network layer, and the PDSN is configured to decode packets at the network layer.

13. The access network of claim 12, wherein the group status message conveys information associated with a packet sent to the PDSN from the access network.

14. The access network of claim 13, wherein the packet is a multicast group registration request or a multicast group de-registration request.

15. The access network of claim 10, wherein, if the group status message indicates to register one or more access terminals identified by the at least one access terminal identifier, the means for updating adds the at least one access terminal identifier to the multicast group membership table for the multicast session identified by the multicast session identifier.

16. The access network of claim 15, further comprising:
means for establishing a BC-A10 connection for the multicast session identified by the multicast session identifier if a BC-A10 connection is not yet active for the multicast session identified by the multicast session identifier.

17. The access network of claim 10, wherein, if the group status message indicates to de-register one or more access terminals identified by the at least one access terminal identifier, the means for updating removes the at least one access terminal identifier from the multicast group membership table for the multicast session identified by the multicast session identifier.

18. The access network of claim 17, further comprising:
means for releasing a BC-A10 connection for the multicast session identified by the multicast session identifier if a BC-A10 connection remains active for the multicast session identified by the multicast session identifier and no access terminals remain registered for the multicast session identified by the multicast session identifier within the multicast group membership table.

19. An access network, comprising:
logic configured to receive a group status message including a multicast session identifier and at least one access terminal identifier; and
logic configured to update a multicast group membership table based on the group status message, the multicast group membership table including a list of access terminal identifiers that have registered for the multicast session identified by the multicast session identifier.

20. The access network of claim 19, wherein the group status message is received at the access network from a packet data serving node (PDSN).

21. The access network of claim 20, wherein the access network is not configured to decode packets at a network layer, and the PDSN is configured to decode packets at the network layer.

22. The access network of claim 21, wherein the group status message conveys information associated with a packet sent to the PDSN from the access network.

23. The access network of claim 22, wherein the packet is a multicast group registration request or a multicast group de-registration request.

24. The access network of claim 19, wherein, if the group status message indicates to register one or more access terminals identified by the at least one access terminal identifier, the logic configured to update adds the at least one access terminal identifier to the multicast group membership table for the multicast session identified by the multicast session identifier.

25. The access network of claim 24, further comprising:
logic configured to establish a BC-A10 connection for the multicast session identified by the multicast session identifier if a BC-A10 connection is not yet active for the multicast session identified by the multicast session identifier.

26. The access network of claim 19, wherein, if the group status message indicates to de-register one or more access terminals identified by the at least one access terminal identifier, the logic configured to update removes the at least one access terminal identifier from the multicast group membership table for the multicast session identified by the multicast session identifier.

27. The access network of claim 26, further comprising:
logic configured to release a BC-A10 connection for the multicast session identified by the multicast session identifier if a BC-A10 connection remains active for the multicast session identified by the multicast session identifier and no access terminals remain registered for the multicast session identified by the multicast session identifier within the multicast group membership table.

28. A computer-readable medium comprising instructions, which, when executed by a machine within an access network, cause the machine to perform operations, the instructions comprising:
program code to receive a group status message including a multicast session identifier and at least one access terminal identifier; and
program code to update a multicast group membership table based on the group status message, the multicast group membership table including a list of access terminal identifiers that have registered for the multicast session identified by the multicast session identifier.

29. The computer-readable medium of claim 28, wherein the group status message is received at the access network from a packet data serving node (PDSN).

30. The computer-readable medium of claim 29, wherein the access network is not configured to decode packets at a network layer, and the PDSN is configured to decode packets at the network layer.

31. The computer-readable medium of claim 30, wherein the group status message conveys information associated with a packet sent to the PDSN from the access network.

32. The computer-readable medium of claim 31, wherein the packet is a multicast group registration request or a multicast group de-registration request.

33. The computer-readable medium of claim 28, wherein, if the group status message indicates to register one or more access terminals identified by the at least one access terminal identifier, the program code to update adds the at least one access terminal identifier to the multicast group membership table for the multicast session identified by the multicast session identifier.

34. The computer-readable medium of claim 33 further comprising:
program code to establish a BC-A10 connection for the multicast session identified by the multicast session identifier if a BC-A10 connection is not yet active for the multicast session identified by the multicast session identifier.

35. The computer-readable medium of claim 28, wherein, if the group status message indicates to de-register one or more access terminals identified by the at least one access terminal identifier, the program code to update removes the at least one access terminal identifier from the multicast group membership table for the multicast session identified by the multicast session identifier.

36. The computer-readable medium of claim 35, further comprising:
program code to release a BC-A10 connection for the multicast session identified by the multicast session identifier if a BC-A10 connection remains active for the multicast session identified by the multicast session identifier and no access terminals remain registered for the multicast session identified by the multicast session identifier within the multicast group membership table.
